(19) United States
(12) Patent Application Publication
(10) Pub. No.: US 2016/0091827 A1
(43) Pub. Date: Mar. 31, 2016

(54) POWDER STORAGE DEVICE AND IMAGE-FORMING APPARATUS

(71) Applicant: FUJI XEROX CO., LTD., Tokyo (JP)

(72) Inventors: Shota OBA, Ebina-shi (JP); Shigeru INABA, Ebina-shi (JP); Norihiro TAMAZAWA, Ebina-shi (JP); Ayumi NOGUCHI, Ebina-shi (JP); Makoto KANNO, Ebina-shi (JP); Seigo SHINOZAKI, Ebina-shi (JP)

(21) Appl. No.: 14/856,140

(22) Filed: Sep. 16, 2015

(30) Foreign Application Priority Data
Sep. 25, 2014 (JP) 2014-194943
Apr. 22, 2015 (JP) 2015-087308

(51) Int. Cl. G03G 15/08

(52) U.S. Cl. CPC G03G 15/0889; G03G 15/0867

(57) ABSTRACT

According to one embodiment of the present invention, there is provided a powder storage device including: a powder container that stores a powder, the powder container including an opening at one end, being horizontally installed and including a protruding line provided on an inner circumferential surface of the powder container; and a lid member that covers the opening, the lid member including an outflow opening for the powder and being held in an irrotational state, wherein the protruding line is capable of transporting the powder to the opening due to rotation of the powder container, a structure for scooping the powder transported through the rotation of the powder container toward near a rotation shaft is not provided, and the powder is made to flow out through the outflow opening.

### CROSS-REFERENCE TO RELATED APPLICATION(S)

This application is based on and claims priority under 35 U.S.C. 119 from Japanese Patent Application Nos. 2014-194943 filed on Sep. 25, 2014, and 2015-087308 filed on Apr. 22, 2015.

### BACKGROUND

1. Technical Field

The present invention relates to a powder storage device and an image-forming apparatus.

2. Background Art

Japanese Patent Laid-Open Publication No. 2004-280064 (hereinafter JP-A-2004-280064) discloses a toner bottle in which a protruding portion for lifting up toner and protruding the toner up to an edge of an opening is formed.

In addition, Japanese Patent Laid-Open Publication No. 2010-210946 (hereinafter JP-A-2010-210946) discloses a developing agent-resupplying container including a transportation member for scooping a developing agent and transporting the developing agent to a discharging opening.

An object of the present invention is to provide a powder storage device with a simple structure.

### SUMMARY

According to one embodiment of the present invention, there is provided a powder storage device including: a powder container that stores a powder, the powder container including an opening at one end, being horizontally installed and including a protruding line provided on an inner circumferential surface of the powder container; and a lid member that covers the opening, the lid member including an outflow opening for the powder and being held in an irrotational state, wherein the protruding line is capable of transporting the powder to the opening due to rotation of the powder container, a structure for scooping the powder transported through the rotation of the powder container toward near a rotation shaft is not provided, and the powder is made to flow out through the outflow opening.

### BRIEF DESCRIPTION OF THE DRAWINGS

Exemplary embodiments of the present invention will de described in detail based on the following figures, wherein:

FIG. 1 is a perspective view of an appearance of an image-forming apparatus as an embodiment of the present invention;

FIG. 2 is a schematic view illustrating an inside configuration of the image-forming apparatus of which the appearance is illustrated in FIG. 1;

FIG. 3 is a perspective view of a toner cartridge as an embodiment which is employed in the image-forming apparatus illustrated in FIGS. 1 and 2;

FIG. 4 is an exploded perspective view of the toner cartridge illustrated in FIG. 3;

FIG. 5 is a side view of the toner cartridge illustrated in FIG. 3; and

FIG. 6 is a sectional view of a proximal portion of a flange in the toner cartridge illustrated in FIG. 3.

### DETAILED DESCRIPTION

Hereinafter, an embodiment of the present invention will be described.

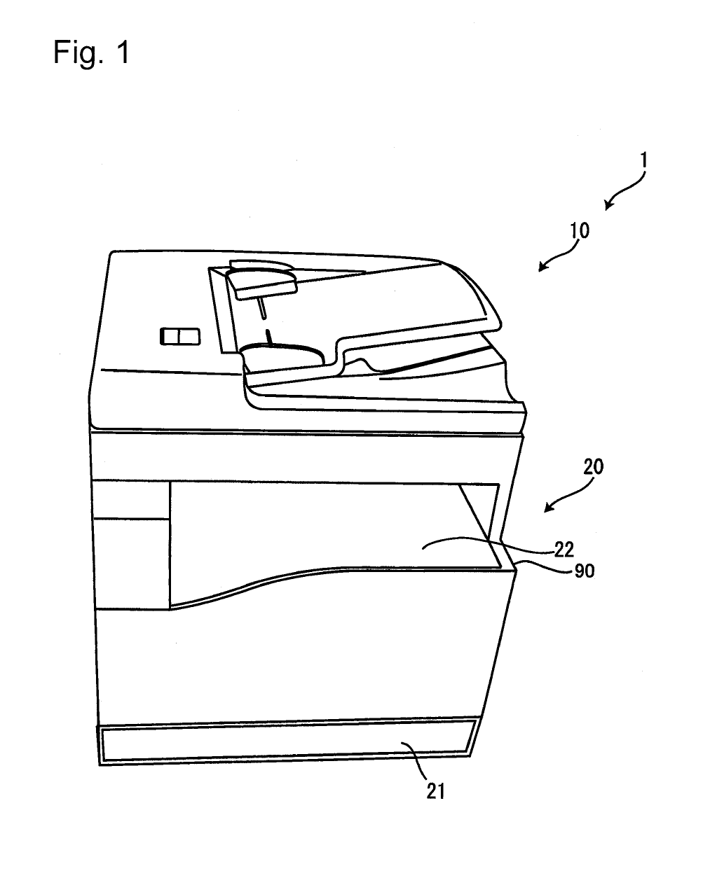

FIG. 1 is a perspective view of the appearance of an image-forming apparatus as an embodiment of the present invention.

An image-forming apparatus 1 includes a scanner 10 and a printer 20.

The scanner 10 is mounted on an apparatus housing 90 which is a framework of the image-forming apparatus 1, and the printer 20 is configured in the apparatus housing 90.

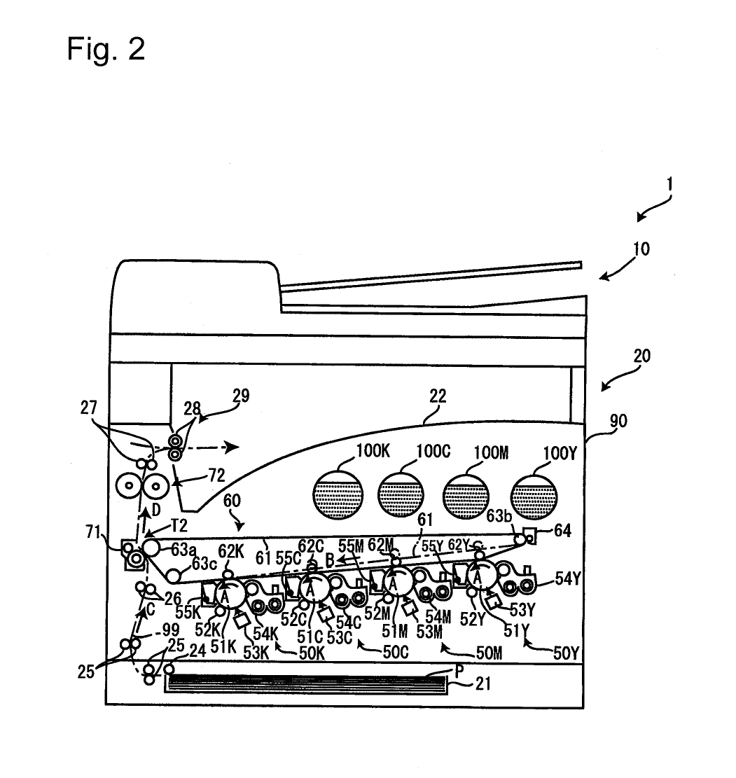

FIG. 2 is a schematic view illustrating the inside configuration of the image-forming apparatus of which the appearance is illustrated in FIG. 1.

The printer 20 has four image-forming sections 50Y, 50M, 50C, and 50K which are almost horizontally arranged in a row. In these image-forming sections 50Y, 50M, 50C, and 50K, toner images are formed using toner of each color of yellow (Y), magenta (M), cyan (C), and black (K), respectively. Hereinafter, when describing common facts of these image-forming sections 50Y, 50M, 50C, and 50K, reference signs Y, M, C, and K which distinctively indicate the colors of the toner will be not attached, and the image-forming sections will be simply denoted as the image-forming sections 50. This shall apply to constituent elements other than the image-forming sections.

Each image-forming section 50 includes a photoreceptor 51. While the photoreceptor 51 is rotated in an arrow A direction with a driving force, an electrostatic latent image is formed on the surface of the photoreceptor, and furthermore, a toner image is formed through development.

Around the photoreceptor 51 in each image-forming section 50, a charger 52, a stepper 53, a developer 54, a primary transfer device 62, and a cleaner 55 are provided. Here, the primary transfer device 62 is placed at a location at which the primary transfer device 62 sandwiches an intermediate transfer belt 61 described below with the photoreceptor 51. The primary transfer device 62 is an element provided in an intermediate transfer section 60 described below, not in the image-forming section 50.

The charger 52 uniformly charges the surface of the photoreceptor 51.

In the stepper 53, the uniformly-charged photoreceptor 51 is irradiated with light for exposure modulated on the basis of an image signal, whereby an electrostatic latent image is formed on the photoreceptor 51.

The developer 54 develops the electrostatic latent image formed on the photoreceptor 51 using toner of colors corresponding to the respective image-forming sections 50, thereby forming a toner image on the photoreceptor 51.

The primary transfer device 62 transfers the toner image formed on the photoreceptor 51 onto the intermediate transfer belt 61 described below.

The cleaner 55 removes toner and the like remaining on the photoreceptor 51 after the transfer of the toner image from the photoreceptor 51.

The intermediate transfer section 60 is disposed on the four image-forming sections 50. In addition, the intermediate transfer section 60 is provided with the intermediate transfer belt 61. The intermediate transfer belt 61 is supported by a plurality of rolls such as a drive roll 63a, a driven roll 63b, and a tension roll 63c. In addition, the intermediate transfer belt 61 is driven by the drive roll 63a and circulates in an arrow B direction along a circulation path including a path that is along with the four photoreceptors 51 provided in the four image-forming sections 50.

Individual toner images on the respective photoreceptors 51 are transferred with an action of the primary transfer device 62 so as to be sequentially overlapped with each other on the intermediate transfer belt 61. The toner images transferred onto the intermediate transfer belt 61 are transported to a secondary transfer location T2 with the intermediate transfer belt 61. A secondary transfer device 71 is provided in the second transfer location T2, and the toner images on the intermediate transfer belt 61 are transferred onto paper P, which has been transported to the secondary transfer location T2, with an action of the secondary transfer device 71. The transportation of the paper P will be described below. Toner and the like remaining on the intermediate transfer belt 61 after the transfer of the toner images to the paper P are removed from the intermediate transfer belt 61 using a cleaner 64.

Above the intermediate transfer section 60, a toner cartridge 100 storing toner of individual color is provided. When toner in the developer 54 is consumed for development, toner is resupplied to the developer 54 from the toner cartridge 100 storing toner of the corresponding color through a toner resupply path which is not illustrated. The toner cartridge 100 is configured to be attachable to and detachable from the apparatus housing 90, and, when becoming empty, the toner cartridge is removed, and a new toner cartridge 100 is mounted.

A sheet of paper P is picked up from a paper tray 21 using a pickup roll 24 and is transported over a transportation path 99 in an arrow C direction to a timing adjustment roll 26 using a transportation roll 25. The paper P that has been transported to the timing adjustment roll 26 is sent to the secondary transfer location using the timing adjustment roll 26 so that the paper reaches the secondary transfer location T2 in accordance with a timing at which the toner images on the intermediate transfer belt 61 reach the secondary transfer location T2. At the secondary transfer location T2, the toner images are transferred from the intermediate transfer belt 61 to the paper P sent out using the timing adjustment roll 26 with an action of the secondary transfer device 71. The paper P to which the toner images have been transferred is further transported in an arrow D direction to pass through a fixing device 72. The toner images on the paper P are heated and pressurized using the fixing device 72 so as to be fixed onto the paper P. As a result, an image made up of the fixed toner images is printed on the paper P. The paper onto which the toner images have been fixed using the fixing device 72 is further transported using a transportation roll 27 and is sent out onto a paper ejection tray 22 through a paper ejection hole 29 using a paper ejection roll 28.

Next, the structure of the toner cartridge 100 will be described.

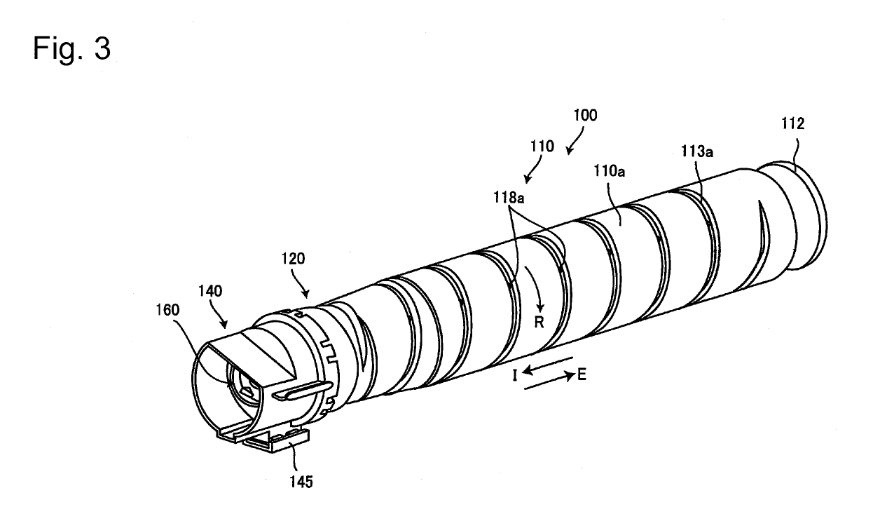

FIG. 3 is a perspective view of a toner cartridge as an embodiment which is employed in the image-forming apparatus illustrated in FIGS. 1 and 2.

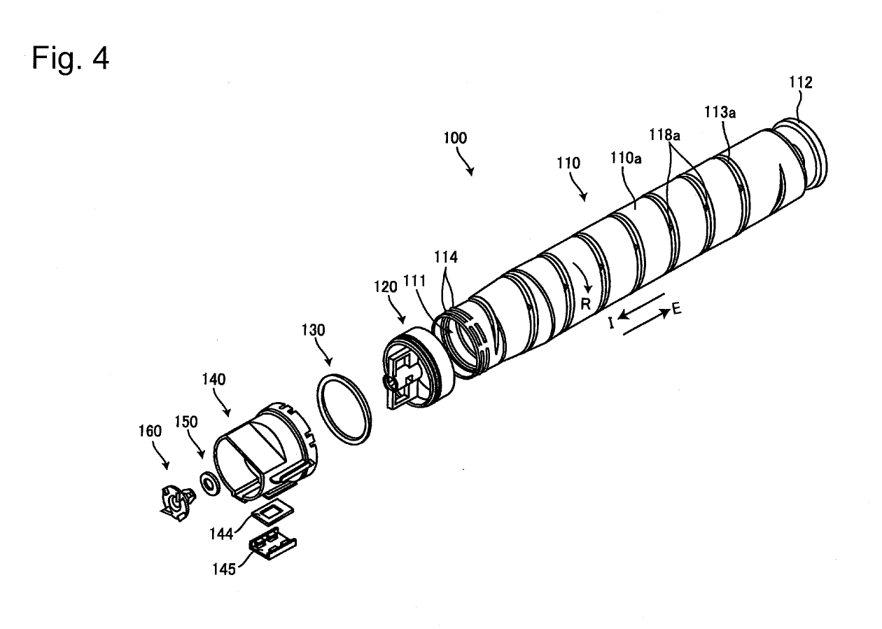

In addition, FIG. 4 is an exploded perspective view of the toner cartridge illustrated in FIG. 3.

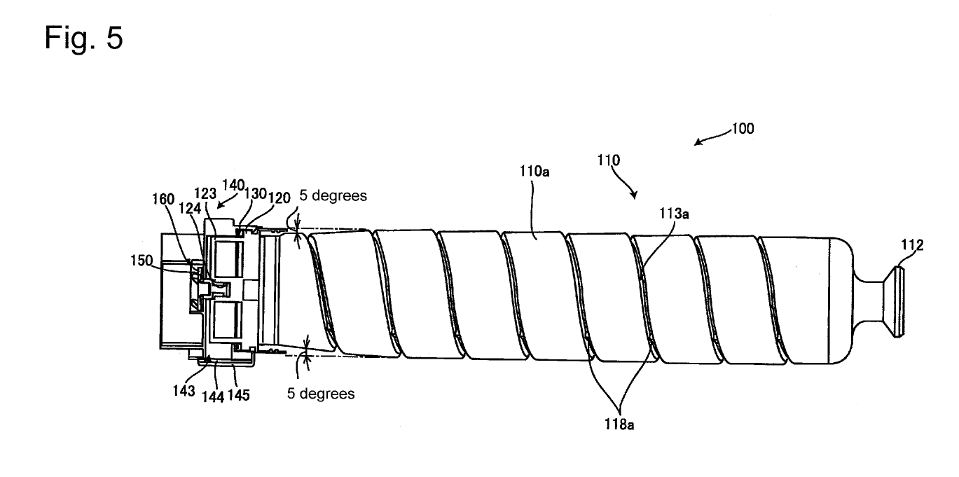

In addition, FIG. 5 is a side view of the toner cartridge illustrated in FIG. 3. However, FIG. 5 illustrates a section of the toner cartridge from which a toner bottle is removed.

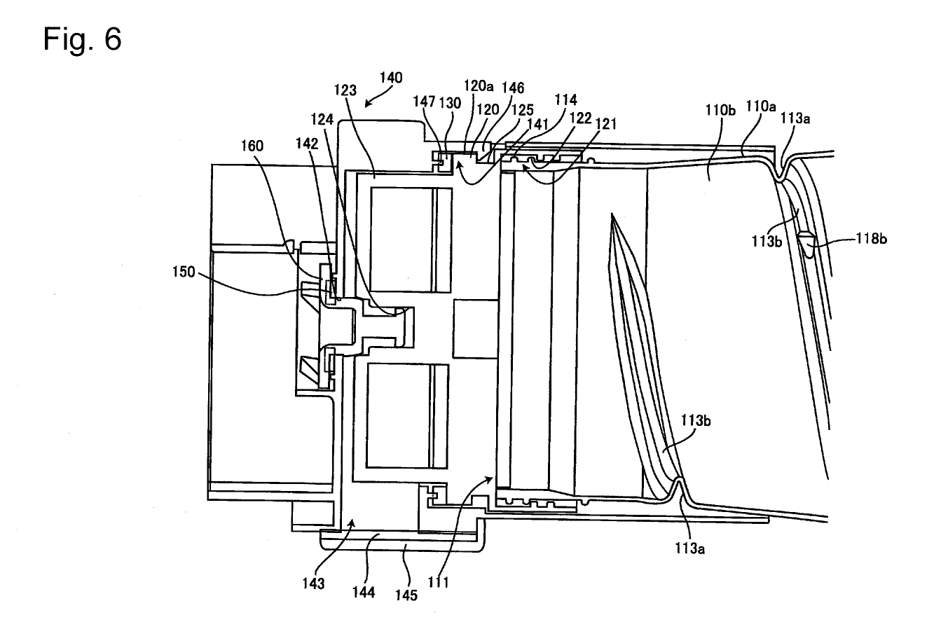

Furthermore, FIG. 6 is a sectional view of a proximal portion of a flange in the toner cartridge illustrated in FIG. 3.

As illustrated in FIG. 4, the toner cartridge 100 has a toner bottle 110, a stirring member 120, a sealing member 130, a flange 140, another sealing member 150, and a coupling 160. This toner cartridge 100 corresponds to an example of a powder storage device mentioned in the present invention. In addition, the toner bottle 110 corresponds to an example of a powder container. Furthermore, the stirring member 120 corresponds to an example of a stirring member, and the coupling 160 corresponds to an example of a portion for receiving a driving force of the stirring member. Furthermore, the flange 140 corresponds to an example of a lid member.

The toner cartridge 100 is assembled in a state illustrated in FIG. 3 with toner stored in the toner bottle 110, and the toner cartridge 100 in the above-described assembled state is fitted into the image-forming apparatus 1 illustrated in FIGS. 1 and 2 and is thus horizontally installed. In addition, when the toner bottle 110 becomes empty, the toner cartridge 100 is pulled out in an arrow E direction, and a new cartridge 100 is fitted in.

The toner bottle 110 forms a substantially cylindrical shape, has an opening 111 at one end, and stores toner therein. In addition, a knob 112 for gripping the toner cartridge when the toner cartridge 100 is pulled out from the image-forming apparatus 1 is provided at the other end. In addition, a spirally-extending groove 113a is formed on an outer circumferential surface 110a of the toner bottle 110. However, this spiral groove 113a is interrupted by a reinforcing rib 118a. That is, on the outer circumferential surface 110a of the toner bottle 110, one intermittent and spirally-extending groove 113a is formed.

The rear surface of the groove 113a protrudes from an inner circumferential surface 110b of the toner bottle 110. That is, on the inner circumferential surface 110b of the toner bottle 110, one spirally-extending protruding line 113b (refer to FIG. 6) is formed. However, this protruding line 113b extends while being interrupted by a rear surface 118b of the reinforcing rib 118a provided on the outer circumferential surface 110a. As described below, the toner bottle 110 rotates in an arrow R direction illustrated in FIGS. 3 and 4. This toner bottle 110 is filled with toner (not illustrated), and, when the toner bottle 110 rotates, the toner is transported toward the opening 111 due to the spiral protruding line 113b on the inner circumferential surface 110b.

In the present embodiment, the toner in the toner bottle 110 is toner having a compression ratio in a range of 0.35 to 0.45 and a low fluidity. In the toner bottle 110 of the present embodiment, as illustrated in FIG. 5, a portion near the opening 111 contracts toward the opening 111 at a slope of approximately five degrees with respect to the rotation shaft. It has been confirmed that, when the slope is 12 degrees or less, even toner having a compression ratio in a range of 0.35 to 0.45 can be smoothly transported toward the opening 111 due to the protruding line 113b on the inner circumferential surface 110b.

As described above, the compression ratio is desirably in a range of 0.35 to 0.45. The reasons therefore are as described below. When the compression ratio is lower than 0.35, the fluidity is too high, and toner is excessively supplied, which is not preferable. When the compression ratio exceeds 0.45, the fluidity is too low, and there is a possibility of toner being stuck, which is not preferable.

Hereinafter, an example of a toner having a compression ratio in a range of 0.35 to 0.45 and comparative examples of toner having compression ratios of 0.34 and 0.46 will be described.

(Preparation of Resin Fine Particle Dispersion Liquid (1))

| | |
|---|---|
| Bisphenol A-ethylene oxide 2 mol-adduct | 25 parts |
| Bisphenol A-propylene oxide 2 mol-adduct | 25 parts |
| Terephthalic acid | 30 parts |
| Succinic acid | 5 parts |
| Trimellitic anhydride | 15 parts |

The above-described components are injected into a round-bottom flask equipped with a stirring device, a nitrogen introduction tube, a thermometer, and a rectifying tower and are heated to 200° C. using a mantle heater. Next, nitrogen gas is introduced into the flask through a gas introduction tube, and the components are stirred together while maintaining an inert gas atmosphere in the flask. After that, dibutyltin oxide 0.05 parts is added to 100 parts of a raw material mixture, and a reaction is performed for four hours while maintaining the temperatures of the reactants at 200° C., thereby obtaining a resin (1).

Next, the obtained resin (1) is sent to an emulsification device (CAVITRON CD1010, manufactured by Eurotec, Ltd.) in a molten state at a rate of 100 g/minute. Diluted ammonia water with a concentration of 0.40%, which has been obtained by diluting reagent ammonia water with ion exchange water, is put into a separately-prepared aqueous medium tank and is sent to the emulsification device at a rate of 0.1 liters/minute at the same time as the molten resin while being heated to 120° C. with a heat exchanger. In this state, the emulsification device is operated under conditions of a rotation rate of a rotor of 60 Hz and a pressure of 0.49 MPa (5 kg/cm²), thereby obtaining a resin fine particle dispersion liquid (1).

(Preparation of Release Agent Dispersion Liquid)

—Release Agent Dispersion Liquid (1)—

| | |
|---|---|
| Polyethylene wax (manufactured by Toyo Petrolite Co., Ltd., | 50 parts |
| Polywax 725, melting temperature: 102° C.) | |
| Anionic surfactant (manufactured by DKS Co., Ltd., | 5 parts |
| NEOGEN RK) | |
| Ion exchange water | 200 parts |

Individual components described above are mixed together, and the mixture is heated and melted at 110° C., is dispersed using a homogenizer (manufactured by IKA Inc., ULTRA TURRAX T50), and is subjected to a dispersion treatment using a Manton-Gaulin high-pressure homogenizer (manufactured by Gaulin), thereby preparing a release agent dispersion liquid (1) (with a concentration of a release agent of 20%) obtained by dispersing a release agent having a volume average particle diameter of 220 nm.

(Preparation of Colorant Dispersion Liquid (1))

| | |
|---|---|
| Cyan pigment (manufactured by Dainichiseika Color & | 1000 parts |
| chemicals Mfg. Co., Ltd., Pigment Blue 15:3 (copper | |
| phthalocyanine)) | |
| Anionic surfactant (manufactured by DKS Co., Ltd., | 150 parts |
| NEOGEN R) | |
| Ion exchange water | 9000 parts |

The above-described components are mixed together, are melted, and are dispersed for approximately one hour using a high-pressure impact-type disperser ALTIMIZER (manufactured by Sugino Machine Limited, HJP30006), thereby preparing a colorant dispersion liquid (1) obtained by dispersing a colorant (cyan pigment). In the colorant dispersion liquid (1), the volume-average particle diameter of the colorant (cyan pigment) is 0.15 μm, and the concentration of colorant particles is 23%.

(Production of Toner Particles)

| | |
|---|---|
| Resin fine particle dispersion liquid (1) | 400 parts |
| Release agent dispersion liquid (1) | 50 parts |
| Colorant dispersion liquid (1) | 22 parts |

These dispersion liquids are added to a round stainless flask, subsequently, 1.5 parts of a 10% aqueous solution of polyaluminum chloride (manufactured by Asada Chemical Industry Co., Ltd.) is introduced into the flask, and the pH of the system is adjusted to be 2.5 using a 0.1 N aqueous solution of nitric acid. After that, the components are stirred at room temperature for 30 minutes, then, are mixed together and dispersed using a homogenizer (manufactured by IKA Inc., ULTRA TURRAX T50), are heated to 45° C. under stirring in an oil bath for heating, and are held for 30 minutes. Next, 50 parts of the resin dispersion liquid is added thereto, and then the components are heated to 50° C. and furthermore are held for one hour.

The obtained substance is observed using an optical microscope, and it is confirmed that aggregated particles with particle diameters of approximately 7.5 μm are generated. The pH of the substance is adjusted to be 7.5 using an aqueous solution of sodium hydroxide, then, the substance is heated to 80° C. using an oil bath for heating, and is held as it is for two hours. After being cooled to room temperature, the substance is filtered, is sufficiently washed with ion exchange water, and then is dried using a vacuum dryer, thereby obtaining toner particles 1.

1.7 Parts of colloidal silica (manufactured by Nippon Aerosil Co., Ltd., R972) are externally added to 100 parts of the obtained toner particles, and the components are mixed together using a Henschel mixer, thereby obtaining toner for developing an electrostatic charge image 1 with a compression ratio of 0.34.

1.5 Parts of colloidal silica (manufactured by Nippon Aerosil Co., Ltd., R972) are externally added to 100 parts of the obtained toner particles, and the components are mixed together using a Henschel mixer, thereby obtaining toner for developing an electrostatic charge image 2 with a compression ratio of 0.35.

1.2 Parts of colloidal silica (manufactured by Nippon Aerosil Co., Ltd., R972) are externally added to 100 parts of the obtained toner particles, and the components are mixed together using a Henschel mixer, thereby obtaining toner for developing an electrostatic charge image 3 with a compression ratio of 0.4.

0.7 Parts of colloidal silica (manufactured by Nippon Aerosil Co., Ltd., R972) are externally added to 100 parts of the obtained toner particles, and the components are mixed together using a Henschel mixer, thereby obtaining toner for developing an electrostatic charge image 4 with a compression ratio of 0.44.

0.5 Parts of colloidal silica (manufactured by Nippon Aerosil Co., Ltd., R972) are externally added to 100 parts of the obtained toner particles, and the components are mixed together using a Henschel mixer, thereby obtaining toner for developing an electrostatic charge image 5 with a compression ratio of 0.45.

0.4 Parts of colloidal silica (manufactured by Nippon Aerosil Co., Ltd., R972) are externally added to 100 parts of the obtained toner particles, and the components are mixed together using a Henschel mixer, thereby obtaining toner for developing an electrostatic charge image 6 with a compression ratio of 0.46.

(Manufacturing of Electrostatic Charge Image Developing Agent)

A solution of a coating agent resin obtained by mixing and stirring 1.25 parts of an 80% solution of ethyl acetate of trifunctional isocyante (TAKENATE D 110N, manufactured by Takeda Pharmaceutical Company Limited) and a carbon dispersion liquid obtained by mixing 0.12 parts of carbon black (trade name: VXC-72, manufactured by Cabot Corporation) with 1.25 parts of toluene and stirring and dispersing the components using a sand mill for 20 minutes, and Mn—Mg—Sr ferrite particles (volume-average particle diameter: 35 μm) are injected into a kneader, are mixed and stirred together at normal temperature for five minutes, and then are heated to 150° C. at normal pressure and the solvent is distilled away. Furthermore, the components are mixed and stirred together for 30 minutes, the heater is turned off, and the mixture is cooled to 50° C. The obtained coated carrier is sieved with a 75 μm mesh, thereby producing a carrier. 95 Parts of this carrier and 5 parts of the toner for developing an electrostatic charge image are mixed together using a V blender, thereby obtaining an electrostatic charge image developing agent.

A resin (2) and a rein fine particle dispersion liquid (2) are produced in the same manner as in the production of the resin (1) except that the reaction is performed for Y hours instead of four hours while maintaining the temperature of the reactants at X° C. instead of 200° C. in the production of the resin (1), and toner particles (2) are produced in the same manner as the toner particles (1) except that the resin fine particle dispersion liquid (1) is changed to the resin fine particle dispersion liquid (2).

(Evaluation of Fluidity of Toner)

The compression ratio of toner can be obtained from the following expression using a powder tester (manufactured by Hosokawa Micron Corporation).

Compression ratio=[(hardened apparent density)−(loosened apparent density)]/(hardened apparent density)

Hereinafter, a list of the examples of toner is shown.

TABLE 1

| | Compression ratio | Amount externally added |
|---|---|---|
| Toner 1 | 0.34 | 1.7% |
| Toner 2 | 0.35 | 1.5% |
| Toner 3 | 0.4 | 1.2% |
| Toner 4 | 0.44 | 0.7% |
| Toner 5 | 0.45 | 0.5% |
| Toner 6 | 0.46 | 0.4% |

The toner bottle 110 illustrated in FIGS. 3 to 6 will be explained again.

A male screw 114 is formed near the opening 111 on the outer circumferential surface 110a of the toner bottle 110. A female screw 122 (refer to FIG. 6) of the stirring member 120 is fitted into the male screw 114, whereby the stirring member 120 is fixed to the toner bottle 110. Therefore, the toner bottle 110 and the stirring member 120 integrally rotate.

The stirring member 120 has an open cylindrical section 121 on the toner bottle 110 side, and a female screw 122 is formed on the inner circumferential surface of the cylindrical member 121. In addition, the stirring member 120 is provided with a stirring blade 123 protruding toward the flange 140 side. In the flange 140 as well, a hollow tubular section 141 is formed to be open toward the toner bottle 110 side as illustrated in FIG. 6. The stirring blade 123 in the stirring member 120 is disposed in the tubular section 141 in the flange 140. The stirring blade 123 plays a role of preventing the aggregation of toner which has moved into the flange 140 from the opening 111 of the toner bottle 110 by stirring the toner in a direction in which the toner revolves around the rotation shaft (the arrow R direction). A fitting hole 124 is provided at the tip of the stirring blade 123. On the other hand, a through hole 142 is formed in the flange 140 at a location facing the fitting hole 124. The coupling 160 is fitted into the through hole 142 from the outside (the left side in FIG. 6) of the flange 140 and is inserted into the fitting hole 124. When the toner cartridge 100 is fitted into the image-forming apparatus 1 (refer to FIGS. 1 and 2), the coupling 160 is bonded to a coupling (not illustrated) in the main body of the apparatus. In addition, the coupling 160 is rotary-driven using a motor (not illustrated) provided in the apparatus main body through the coupling in the apparatus main body. The coupling 160 is inserted into the fitting hole 124 of the stirring member 120, and, when the coupling 160 is rotated, the stirring member 120 is also integrally rotated with the coupling. In addition, since the stirring member 120 is fixed to the toner bottle 110, when the stirring member 120 is rotated, the toner bottle 110 is also integrally rotated with the stirring member.

A locking groove 125 revolving once in the revolving direction is provided on an outer circumferential surface 120a of the stirring member 120. On the other hand, a locking claw 146 which is inserted into the locking groove 125 is provided in the flange 140. The locking claw 146 slides in a rotation direction (the arrow R direction illustrated in FIGS. 3 and 4) together with the locking groove 125 while fixing the flange 140 to the stirring member 120 in a rotation shaft direction (the horizontal direction in FIG. 6). When the toner cartridge 100 is fitted into the image-forming apparatus 1, the flange 140 is fixed to the apparatus main body in an irrotational state. Therefore, the stirring member 120 rotates while sliding with the locking claw 146 of the flange 140.

The ring-shaped sealing member 130 is sandwiched between the stirring member 120 and the flange 140 and is pressed due to a round protruding line 147 of the flange 140. This sealing member 130 prevents toner from leaking out through between the stirring member 120 and the flange 140. In addition, the ring-shaped sealing member 150 is disposed at a location at which the sealing member surrounds the through hole 142 of the flange 140 so as to prevent the leakage of toner from the through hole 142 of the flange 140.

The flange 140 plays a role of a lid for the toner bottle 110 and has an outflow opening 143 through which toner flows out. The proximity of the outflow opening 143 is covered with another sealing member 144. Furthermore, the outflow opening 143 and the sealing member 144 are covered with a shutter 145. The shutter 145 is opened when the toner cartridge 100 is fitted into the image-forming apparatus 1 and is closed when the toner cartridges are removed from the image-forming apparatus. As described above, when the toner cartridge 100 is fitted into the image-forming apparatus 1, the shutter 145 is opened, and furthermore, the flange 140 is held in an irrotational state. Furthermore, the coupling (not illustrated) in the apparatus main body and the coupling 160 in the toner cartridge 100 are bonded to each other. The coupling 160 is rotary-driven using the motor in the apparatus main body through the coupling in the apparatus main body. In addition, the stirring member 120 in the toner cartridge 100 and the toner bottle 110 are rotated with this rotary driving. Toner in the toner bottle 110 is transported toward the opening 111 with the rotation of the toner bottle 110, is transported out from the opening 111, and moves into the flange 140. The toner that has moved into the flange 140 flows out from the toner cartridge 100 through the outflow opening 143 while being stirred with the stirring blade 123 in the stirring member 120.

The toner cartridge 100 as the first embodiment described herein represents toner cartridges 100Y, 100M, 100C, and 100K illustrated in FIG. 2. That is, toner flowing out from the toner cartridge 100 is supplied to the corresponding developer 54 and is subjected to the formation of a toner image.

Here, the toner cartridge 100 of the embodiment is rotary-driven through the coupling 160 provided on the rotation shaft. Therefore, the configuration of a drive system for rotary-driving the toner cartridge becomes simple compared with a configuration in which a gear is formed in the toner bottle 110 and the gear is driven. In addition, no space is required to dispose a gear (refer to FIG. 3) and the like between the four toner cartridges 100Y, 100M, 100C, and 100K illustrated in FIG. 2, and thus space may be saved.

In addition, in the case of the toner cartridge 100 of the present embodiment, while the toner bottle 110 contracts toward the opening 111 at a slope of approximately five degrees, in other parts, the toner cartridge 100 does not include any openings that strongly contract toward the rotation shaft unlike JP-A-2004-280064 and JP-A-2010-210946, and thus does not need to have a structure (a scooping shape, member, or the like) for scooping toner toward the opening, has a simple structure, and furthermore, the toner cartridge 100 becomes suitable for the storage and sending of toner having a low fluidity.

Meanwhile, in the present embodiment, while one protruding line 113b, which extends intermittently and plays a role of transporting toner, is formed on the inner circumferential surface 110b of the toner bottle 110, the number of the protruding lines 113b playing a role of transporting toner is not necessarily only one, and a plurality of short protruding lines 113b that are distributed in a dispersive manner may be provided.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and there equivalents.

What is claimed is:

1. A powder storage device comprising:
a powder container that stores a powder, the powder container including an opening at one end, being horizontally installed and including a protruding line provided on an inner circumferential surface of the powder container; and
a lid member that covers the opening, the lid member including an outflow opening for the powder and being held in an irrotational state,
wherein the protruding line is capable of transporting the powder to the opening due to rotation of the powder container,
a structure for scooping the powder transported through the rotation of the powder container toward near a rotation shaft is not provided, and
the powder is made to flow out through the outflow opening.

2. The powder storage device according to claim 1,
wherein the protruding line is an intermittent and spirally-extending protruding line.

3. The powder storage device according to claim 1,
wherein the lid member includes a hollow tubular section open toward the powder container,
a stirring member disposed in the tubular section and fixed to the powder container to integrally rotate with the powder container so as to stir the powder in the tubular section in a direction in which the powder revolves around the rotation shaft is further provided.

4. The powder storage device according to claim 3,
wherein the stirring member including a driving force-receiving portion penetrating the lid member in a rotation shaft direction and transmitting a rotary driving force received in the driving force-receiving portion to the powder container.

5. A powder storage device comprising:
a powder container that stores a powder, the powder container including an opening at one end, being horizontally installed and including a protruding line provided on an inner circumferential surface of the powder container; and
a lid member that covers the opening, the lid member including an outflow opening for the powder and being held in an irrotational state,
wherein the protruding line is capable of transporting the powder to the opening due to rotation of the powder container, and
the powder container includes a portion contracting toward the one end at a slope of 12 degrees or less with respect to a rotation shaft and includes an opening at the one end with a contracted diameter compared with a diameter of a portion away from the one end.

6. An image-forming apparatus including a powder storage device that stores a powder and forms an image using the powder taken out from the powder storage device,
wherein the powder storage device includes:
a powder container that stores a powder, the powder container including an opening at one end, being horizontally installed and including a protruding line provided on an inner circumferential surface of the powder container; and
a lid member that covers the opening, the lid member including an outflow opening for the powder and being held in an irrotational state,
wherein the protruding line is capable of transporting the powder to the opening due to rotation of the powder container, a structure for scooping the powder transported through the rotation of the powder container toward near a rotation shaft is not provided, and the powder is made to flow out through the outflow opening.

7. An image-forming apparatus including a powder storage device that stores a powder and forms an image using the powder taken out from the powder storage device,
wherein the powder storage device includes:
a powder container that stores a powder, the powder container including an opening at one end, being horizontally installed and including a protruding line provided on an inner circumferential surface of the powder container; and
a lid member that covers the opening, the lid member including an outflow opening for the powder and being held in an irrotational state,
wherein the protruding line is capable of transporting the powder to the opening due to rotation of the powder container, and the powder container includes a portion contracting toward the one end at a slope of 12 degrees or less with respect to a rotation shaft and includes an opening at the one end with a contracted diameter compared with a diameter of a portion away from the one end.
